(19) United States
(12) Patent Application Publication
(10) Pub. No.: US 2017/0309200 A1
(43) Pub. Date: Oct. 26, 2017

(54) SYSTEM AND METHOD TO VISUALIZE CONNECTED LANGUAGE

(71) Applicant: National Reading Styles Institute, Inc., Syosset, NY (US)

(72) Inventors: Nicholas A. Carbo, Syosset, NY (US); Marie Carbo, Syosset, NY (US)

(21) Appl. No.: 15/137,729

(22) Filed: Apr. 25, 2016

(51) Int. Cl. G09B 17/00; G10L 15/04; G10L 25/78; G09B 5/02

(52) U.S. Cl. CPC G09B 17/003; G10L 25/78; G09B 5/02; G10L 15/04; G10L 2025/783

(57) ABSTRACT

Systems and methods for visualizing connected speech are disclosed. The systems and methods include receiving reading content as vocalized speech; analyzing the vocalizations to determine the nature and duration of the vocalized breath strings of a text when read aloud; and generating highlighting for beginning and end points to be the visual content based on the nature and duration of the vocalized, breath strings.

### BACKGROUND OF THE INVENTION

### Field of the Invention

This disclosure relates to a computerized reading learning system and method, and more particularly, to a system and method for visualizing connected language as it is uttered and heard to move a student effectively through the process of learning how to read.

### Description of the Related Art

Techniques for teaching students how to read are well known. Many prior art techniques include providing a student with a story or other written content and outputting a pre-stored reading of the story to the student who will follow along the written content with its reading.

Other prior art systems can display text on a display device and highlight the text as the pre-stored reading of the text as output. These systems typically highlight the text on a word-by-word, or line-by-line basis. For a student learning to read, a word-by-word or a line-by-line system is not necessarily a representation of natural language, or closely aligned to the text as it is naturally uttered, therefore not being as effective a system, tending to lead to longer learning curves.

This disclosure relates to improvements over these prior art systems.

### SUMMARY OF TIM INVENTION

One embodiment of the invention is a system for visualizing connected language. The system includes a processor effective to receive naturally connected vocalizations of reading content as audio; the system analyzes the vocalizations to determine the duration and connectedness of the vocalized breath strings of the audio; and the system generates highlighting from the beginning to the end points of the breath strings to correspond to the content audio, based on the predetermined vocalized breath string parameters.

Another embodiment of the invention is a method for visualizing connected language. The method includes receiving by the processor textual audio content; analyzing by the processor the text audio to determine the beginning and ending points of the vocalized breath strings; and generating by the processor highlighting to mark text so that it coincide with those beginning and ending points, and is synchronized with the audio of the text as it is uttered, also to coincide with those beginning and ending points for the text being read, based on the predetermined vocalized breath strings.

The system includes a processor effective to receive speech reading content; analyze the speech to determine vocalized breath strings of the speech; and generate highlighting points for the content based on the determined vocalized breath strings.

The method includes receiving by the processor speech reading content; analyzing by the processor the speech to determine vocalized breath strings of the speech; and generating by the processor highlighting points for the content based on the determined vocalized breath strings.

### BRIEF DESCRIPTION OF THE DRAWINGS

The drawings constitute a part of the specification and include exemplary embodiments of the present invention and illustrate various objects and features thereof.

FIG. 1 is a system drawing of a system to visualize connected language in accordance with an embodiment of the invention.

FIG. 2 is a diagram illustrating a system in the prior art.

FIG. 3 is a diagram illustrating a system and method to visualize connected language in accordance with an embodiment of the invention.

FIG. 4 is a flowchart of a method to visualize connected language in accordance with an embodiment of the invention.

FIG. 5 is a flowchart of a method to visualize connected language in accordance with an embodiment of the invention.

FIG. 6 is a flowchart of a method to visualize connected language in accordance with an embodiment of the invention.

### DETAILED DESCRIPTION OF THE PREFERRED EMBODIMENT(S)

Various embodiments of the invention are described hereinafter with reference to the figures. Elements of like structures or function are represented with like reference numerals throughout the figures. The figures are only intended to facilitate the description of the invention or as a limitation on the scope of the invention. In addition, an aspect described in conjunction with a particular embodiment of the invention is not necessarily limited to that embodiment and can be practiced in conjunction with any other embodiments of the invention.

Connected articulated speech is natural speech, and vice-versa. In the present disclosure, in order for a learner to hear, see, and internalize the coordinated sequences of graphemes and phonemes which comprise most language systems, the uttered sounds and written representations of both are represented simultaneously, visually and auditorially. The precise coordination is accomplished by means of a unique combination of phonemic unit selection and audio frequency measurements that are accurate to the nearest millisecond.

The selection and coordination technique used in the present disclosure, which is neither alphabetic nor word-based, is guided rather by the beginning, and end points of the structures and patterns of the connected speech components, referred to as vocalized breath strings. In other words, the technique depends upon the nature and/or degree of clarity of the articulation or utterance, as to tone, duration, expression, breath, quality, and connectedness.

Selection of linked text includes intact and normal vocalized breath strings, and can include speech parameters such as breath aspirations, exhalations, tonal links, tongue flaps, tooth flaps, palate flaps, guttural clicks, or other vocalization(s). In general, the text selection is not dependent on alphabetic structure or syntax.

The vocalized breath string can be a word, or a phrase, or a sentence. The text to be highlighted is preferably matched to the audio representation of the vocalized breath string or breath-connected voiced utterance, to the nearest millisecond. The highlighting selection is directed to spoken text strings, the end of which may be imperceptible to the system but can be manually adjusted. If a single word is isolated and stressed, i.e. is identified as a vocalized breath string, the single word can be selected as the utterance to be highlighted. The selection of the end point of the breath string, i.e., connected language, should allow for an additional one-, two-, ten, or more millisecond delay as a word or breath string buffer. The delay can be varied to system. parameters and operator needs.

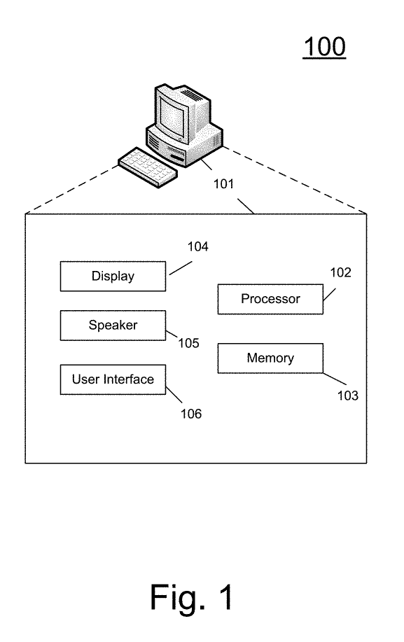

Referring to FIG. 1, there is shown a system 100 for visualizing connected language in accordance with an embodiment of the disclosure. System 100 includes computer 101, processor 102 for controlling the overall operation of system 100, memory 103 for storing programs and data, display 104 for displaying content and highlighting of the content, speaker 105 for outputting audio instructions and reading of the content, and user interface 106 for receiving user and/or operator input.

Processor 102 is specially programmed to analyze speech and identify vocalized breath strings that are used to highlight content (e.g. text) that is displayed on display 104. Speech as used herein can include real time or pre-recorded spoken language, and can correspond at least in part to text that is displayed on a display. Generally, as used herein, speech will refer to a pre-recorded reading of a story that will be audible output along with the display of the text of the story.

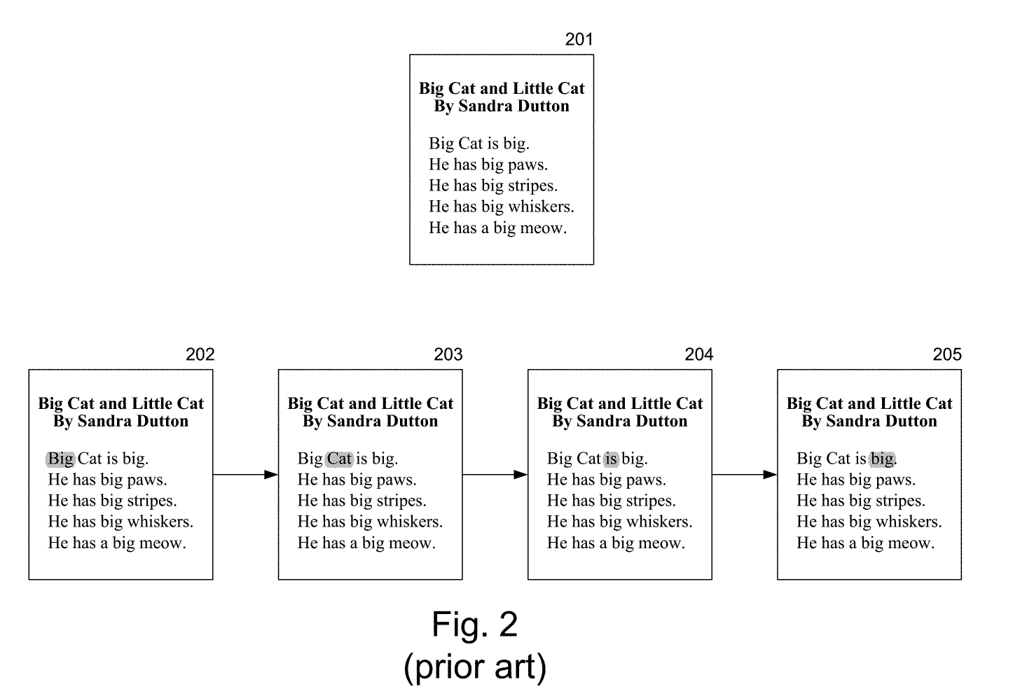

In prior art systems, for example as shown in FIG. 2, text is displayed on a display as shown in 201. In the screen shot series of 202-205, the prior art systems highlight one word at a time or one line at a time. Thus, the sentence “Big Cat is big” ends up being highlighted as “Big - - - Cat - - - is - - - big” (dashes being used to represent time between highlighting of the words), or the entire sentence is highlighted. Even though a system might be outputting read-back of the sentence at a normal language rate, the highlighting occurs unconnected with the language as it is uttered or with regard to the natural connectedness of language strings. This causes a disjunction between the normal speech and the highlighting that delays or inhibits reading progression. Another prior system may display indiscriminate highlighting of an entire line of text, without regard to the audible natural connections or the silences between words.

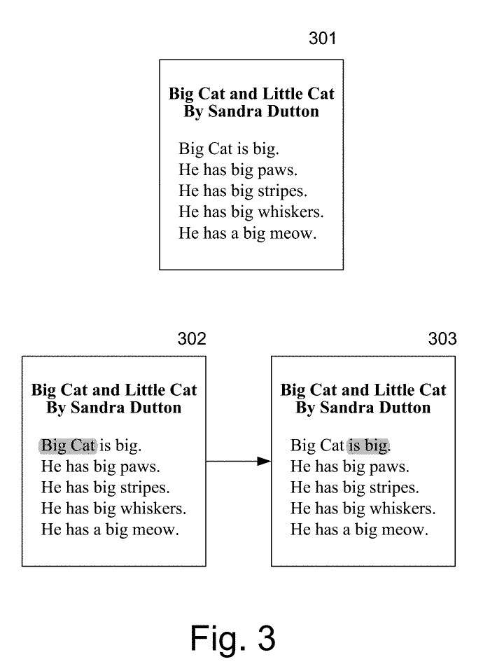

The present disclosure processes the audible speech to generate highlighting that corresponds to natural language, in the way it is uttered in a particular instance. As shown in FIG. 3, the system and method according to the present disclosure starts by displaying the content as shown in 301. In contrast to the prior art systems, system 100 processes the speech (i.e. the read-back of the content) to determine the natural language flow vocalized breath strings) of the speech and then highlights text according to the naturally spoken language. Thus, the same “Big Cat is big” sentence will be highlighted by system 100 as “Big Cat—is big”, which corresponds to how this text is read and how language is naturally connected and articulated in this instance. The correlation between the normal speech, as spoken and heard in, a particular instance and the synchronized highlighting of the text as it is heard and seen greatly accelerates learning.

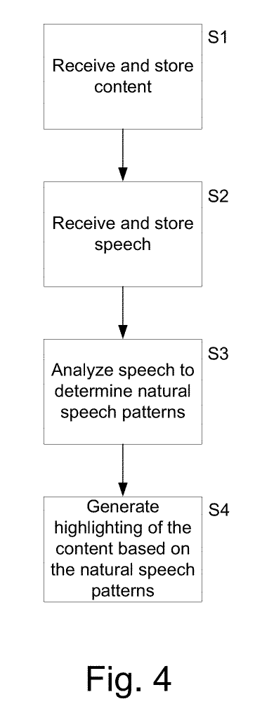

FIG. 4 is a flowchart illustrating a method of visualizing connected language.

In step S1, processor 102 receives and stores content. Content can include text in most written languages and can include stories, poems, magazine and newspaper articles, etc.

Next, in step S2 processor 102 receives and stores speech. The speech is a reading of the particular content. The speech can also include a preview (or an introduction) of spoken words and a prologue of spoken words not included in the displayed text, which may not correspond to content and would not be processed for highlighting. In addition, although in the present embodiment the speech is stored, processor 102 can be programmed to process and highlight in real time.

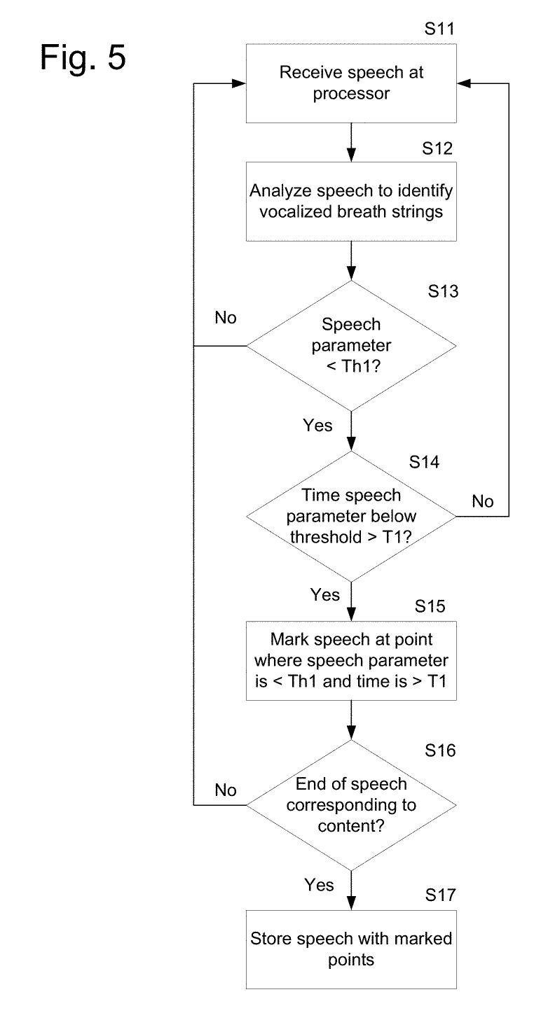

In step S3, processor 102 analyzes the speech to determine the natural and relevant articulation patterns of the speech. This process will be described in greater detail with respect to FIG. 5, below. During this analysis, processor 102 determines the beginning and end points of the structures, connectedness and other patterns of the vocalized breath strings, rather than alphabetic structure, phonemic content or syntax. Processor 102 takes into consideration the nature and/or degree of clarity of the articulation or utterance, as to tone, duration, expression, breath, quality, and connectedness, and can include speech parameters such as breath aspirations, exhalations, tonal links, tongue flaps, tooth flaps, palate flaps, guttural clicks, or other vocalization(s).

Once the natural speech patterns are identified, in step S4 processor 102 generates highlighting of the content based on the determined natural speech patterns. Processor 102 can store the generated highlighting in memory 103 for later playback and display.

FIG. 5 is a flowchart illustrating a method of visualizing connected language.

In step S11 processor 102 receives the audible vocalizations. The speech can be received from memory or through a microphone in real time. In step S12 processor 102 analyzes the speech to identify the vocalized breath strings and the audible silences between breath strings, of a specific kind and length of duration. To do this, processor 102 compares the audio characteristics of the vocalized text to a first threshold Th1. Threshold Th1 is a measure of particular audio level characteristics, or an absence thereof, of specific duration, measured in milliseconds. Processor 102 is not necessarily looking to identify a space (or a silence) between words (although, this correlation may occur), but instead is listening to all the speech parameters in order to identify significant predetermined connections and silences. The speech parameters can include one or more of breath aspirations, exhalations, tonal links, tongue-alveolar flaps, tongue-tooth flaps, palate flaps, guttural clicks, and other vocalizations.

When the speech parameter is not below the threshold Th1, processor 102 continues to analyze the speech in step S12. When the speech parameter is below the threshold. Th1, in step S14 processor 102 counts the time the speech is below the threshold Th1. When the speech parameter rises above the threshold Th1 before a preset time T1 has elapsed, processor 102 continues to analyze the speech. The preset time is above 1 millisecond, but this time can be varied up or down. When the speech parameter does not increase greater than the threshold Th1 for the preset time T processor 102 continues on to step 15 and marks the point in the speech where the speech parameter is below the threshold Th1 for greater than the preset time period T1.

Processor 102 continues to receive, analyze and mark points in the speech as described above until in step S16 processor 102 determines that an end of the speech corresponding to the content is reached. This end can be the actual end of the speech or a preset point that is identified as the end of the content read speech when prologue speech is included. At this point, in step S17 processor 102 stores the speech along with the marked points in memory 103.

Variations of the above process are contemplated. For example, processor 102 can be programmed to analyze, speech in real time. As the speech is received, analyzed and marked, processor 102 can store the speech and marking in memory 103. As another variation, the highlighting can occur in real time as the speech is analyzed. That is, for example, if real time speech is being received and the content is displayed on display 104, processor 102 can highlight the content as the points are identified, with or without any markings. In addition, a first marked point can be set at the beginning of the speech if the be of the speech corresponds to the content or at a later point if there is preview speech to be output before the beginning of the content. Also, the marks can be adjustable by processor 102 or an operator to more accurately reflect natural speech or correspond to the actual and natural phonemic breaks. Other variations are contemplated.

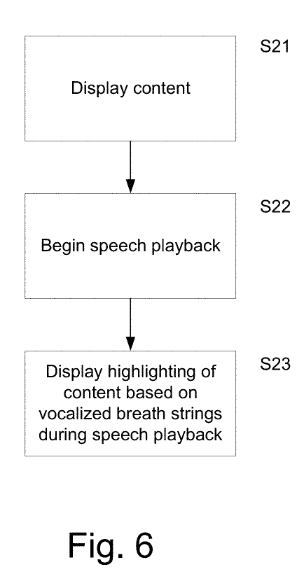

FIG. 6 is a flowchart illustrating a method of visualizing connected language.

When a learner accesses system 100 to begin display of the content and playback of the speech, processor 102 displays part or all of the content on display 104. Processor 102 then starts the speech playback. As the marked points are reached, processor 102 highlights the content identified between the marked points and continues until the end of the content is reached.

The present invention can increase the learning capabilities of a learner by basing the highlighting of a read story text on naturally occurring speech, as it is heard.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system for visualizing connected language, the system comprising:
a processor effective to
receive speech reading content;
analyze the speech to determine vocalized breath strings of the speech; and
generate highlighting beginning and end points for the content based on the determined vocalized breath strings.

2. The system for visualizing connected language of claim 1, wherein to determine the vocalized breath strings, the processor is further effective to
receive the speech;
analyze the speech to determine points in the speech where speech parameters of the speech are below a threshold for a period of time greater than a preset threshold period of time; and
mark each point as a beginning or an end to a vocalized breath string.

3. The system for visualizing connected language of claim 2, further comprising:
a display for displaying the content; and
a speaker for outputting the speech,
wherein the processor is further effective to highlight the content between marked points as the speech corresponding to the content is output.

4. The system for visualizing connected language of claim 2, wherein the threshold is an audio level threshold.

5. The system for visualizing connected language of claim 2, wherein speech parameters include one or more of breath aspirations, exhalations, tonal links, tongue flaps, tooth flaps, palate flaps, guttural clicks, and vocalization.

6. The system for visualizing connected language of claim 2, wherein the predetermined period of time is 1 millisecond.

7. The system for visualizing connected language of claim 2, wherein the processor is further effective to adjust the marked points to coincide with, positions between connected language strings.

8. The system for visualizing connected language of claim 1, further comprising:
a memory for storing the speech.

9. The method for visualizing connected language of claim 1, wherein the processor is further effective to
receive the content; and
store the content in a memory.

10. The system for visualizing connected language of claim 1, wherein the processor is further effective to
display the content on a display; and
highlight the content based on the marked points.

11. A method for visualizing connected language, the method comprising:
receiving by the processor audio of naturally articulated language reading content;
analyzing by the processor the articulated language to identify and determine the beginning and end points of vocalized breath strings; and
generating by the processor highlighting of the beginning and end points for the content based on the predetermined parameters and subsequently measured vocalized breath strings.

12. The method for visualizing connected language of claim 11, wherein determining the vocalized breath strings by the processor comprises:
receiving the audible textual articulations;
analyzing the articulations to determine points in the articulations where measurable beginning and end points constitute legitimate predetermined parameters of the text and audio and are within or beyond a predetermined threshold for a period of time greater than a preset threshold period of time; and
marking each breathstring measurement as a beginning or an end point of a vocalized breath string.

13. The method for visualizing connected language of claim 12, further comprising:
displaying by the processor the content on a display;
outputting by the processor the audio of naturally articulated language reading content through a speaker; and
highlighting the text content between marked points as the textual representation of the audio of naturally articulated language reading content as output.

14. The method for visualizing connected language of claim 12, wherein the threshold is an audio level threshold.

15. The method for visualizing connected language of claim 12, wherein speech parameters include one or more of breath aspirations, exhalations, tonal links, tongue flaps, tooth flaps, palate flaps, guttural clicks, and vocalization.

16. The method for visualizing connected language of claim 12, wherein the predetermined period of time is 1 millisecond.

17. The method for visualizing connected language of claim 12, further comprising:
adjusting the marked points to coincide with positions between words.

18. The method for visualizing connected language of claim 11, further comprising:
storing by the processor the speech in a memory.

19. The method for visualizing connected language of claim 11, further comprising:
receiving by a processor the content; and
storing by the processor the content in a memory.

20. The method for visualizing connected language of claim 11, further comprising:
displaying by the processor the content on a display; and
highlighting the content based on the marked points.
